(19) United States
(12) Patent Application Publication
(10) Pub. No.: US 2006/0032886 A1
(43) Pub. Date: Feb. 16, 2006

(54) Combustion-engined setting tool

(76) Inventors: Hans Gschwend, Buchs (CH); Ulrich Rosenblum, Wangs (CH); Ulrich Schiestl, Feldkirch (AT)

Correspondence Address: ABELMAN, FRAYNE & SCHWAB, 666 THIRD AVENUE, 10TH FLOOR, NEW YORK, NY, 10017, US

(21) Appl. No.: 11/205,261

(22) Filed: Aug. 15, 2005

(30) Foreign Application Priority Data
Aug. 16, 2004 (DE) 10 2004 039 612.4

(51) Int. Cl. B25C 1/14

(52) U.S. Cl. 227/10; 227/2

(57) ABSTRACT

A combustion-engined setting tool for driving a fastening element in a constructional component includes a combustion chamber in which an oxidation medium-fuel mixture is combusted, a device for adjusting an oxidation medium-fuel ratio of the oxidation medium-fuel mixture, and manually-operated adjusting unit for inputting site parameters and connected with the adjusting device for setting the oxidation medium-fuel ratio of the oxidation medium-fuel mixture.

### BACKGROUND OF THE INVENTION

1. Field of the Invention

The present invention relates to a combustion-engined setting tool for driving a fastening element in a constructional component and including a combustion chamber in which an oxidation medium-fuel mixture is combusted, and a device for adjusting an oxidation medium-fuel ratio of the oxidation medium-fuel mixture.

2. Description of the Prior Art

Setting tools of the type described above can operate using gaseous or liquid fuels which are combusted in a combustion chamber, generating gases which drive a setting piston that drives fastening elements in.

Generally, there exists a problem of admixing of a properly proportioned amount of air or oxygen used as an oxidation medium. In particular, air, which is taken from an environment, is subjected to pressure variations which can unfavorably influence the combustion process, when the mixture is too rich or too poor in fuel.

U.S. Pat. No. 6,123,241 discloses a setting tool which is controlled by a microprocessor and includes different sensors for measuring, among others, the pressure of the ambient air and the fuel pressure. The admixing and metering of the fuel from a fuel reservoir and which is fed into the combustion chamber, is controlled by the microprocessor based on data acquired by the sensors. The microprocessor cooperates, to this end, with a control valve that controls flow of fuel.

The drawbacks of the known setting tool consists in that, on one hand, the pressure sensor is rather expensive, which increases the manufacturing costs. On the other hand, the sensor is very sensitive so that with high accelerations, which characterize a setting process, and with a high load produced by dirt particles, the sensor can generate erroneous data or fail completely.

German publication DE 42 43 617 A1 discloses a combustion-engined setting tool that includes a gas inlet valve which opens mechanically during an operational process, providing for flow of fuel from a fuel reservoir into a storage chamber that communicates with environment. The connection of the storage chamber with the environment permits to equalize the pressure in the storage chamber with the ambient pressure. This insures that an adapted volume of the air-fuel mixture reaches the combustion chamber. The fuel is fed from the storage chamber to the combustion chamber at a predetermined time.

The drawback of this setting tool of DE 42 43 617 A1 consists in that the connection of the storage chamber with the environment can result in fuel losses.

Accordingly, an object of the present invention is to provide a setting tool of the type described above and in which the above-discussed drawbacks of the known setting tools are eliminated.

Another object of the present invention is a setting tool of the type discussed above which would permit a simpler adjustment of the adapted, metered-out amount of fuel and which is sufficiently robust.

### SUMMARY OF THE INVENTION

These and other objects of the present invention, which will become apparent hereinafter, are achieved according to the invention, by providing manually-operated adjusting means for inputting site parameters and connected with the adjusting device for setting the oxidation medium-fuel ratio of the oxidation medium-fuel mixture.

The adjusting means permits the tool operator to input site parameters such as e.g., height over the sea level or meteorological parameters, which determine an optimal volume of oxidation medium-fuel mixture or optimal metering. These parameters are not necessary at each setting process. Only when the setting tool is displaced to another height over the sea level from the previous height over sea level at which the setting tool operated, a new site parameter(s) need be inputted. The adjusting means is less sensitive than a pressure sensor and can be more easily produced.

Advantageously, the adjusting device includes a metering device for metering a measured metered-out fuel volume and including a control unit. The adjusting means communicates with the control unit which determines the measured metered-out fuel volume based on the site parameters communicated by the adjusting means. In this way, the metering device can meter out a fuel volume, which is well adapted to the environmental conditions, for each setting process.

The setting tool, at that, is easily handled as the metering can be effected automatically.

Advantageously, the adjusting means comprises means for manually inputting a geographical height as a site parameter. As the height over the sea level (geographical height) is correlated with the ambient air pressure, it is this parameter that is input instead of ambient pressure that is very important for the fuel metering. The advantage of this consists in that an operator can more easily determine the height over the sea level than the ambient pressure. An approximate determination of the geographical height suffices. Thereby, the operator by an easy actuation or operation of the adjusting means can indirectly input the ambient pressure into the control means of the setting tool.

In order to be able to correct the weather-dependent oscillations of the ambient pressure, the adjusting means includes means for inputting meteorological conditions as site parameters.

In order to provide for a precise adjustment, the adjusting means is provided with one or more scale, with the scale being formed as meter scale showing the height over the sea level in meters. Also, a scale showing weather or meteorological conditions can be provided.

Advantageously, the adjusting means includes one or more selector switches. A selector switch is generally very robust and has a long service life. A selector switch can be formed as a mechanical and/or electronic switch and can include, e.g., an adjusting wheel that can be only manually adjusted.

The novel of the features of the present invention, which are considered as characteristic for the invention, are set forth in the appended claims. The invention itself, however, both as to its construction and its mode of operation, together with additional advantages and objects thereof, will be best understood from the following detailed description of a preferred embodiment, when read with reference to the accompanying drawings.

### BRIEF DESCRIPTION OF THE DRAWINGS

The drawings show:

FIG. 1 a side, partially cross-sectional view of a combustion-engined setting tool according to the present invention in an initial position thereof; and

FIG. 2 a detail view, at an increased scale, of a section of the inventive setting tool shown in FIG. 1 and designated with a reference marking II in FIG. 1.

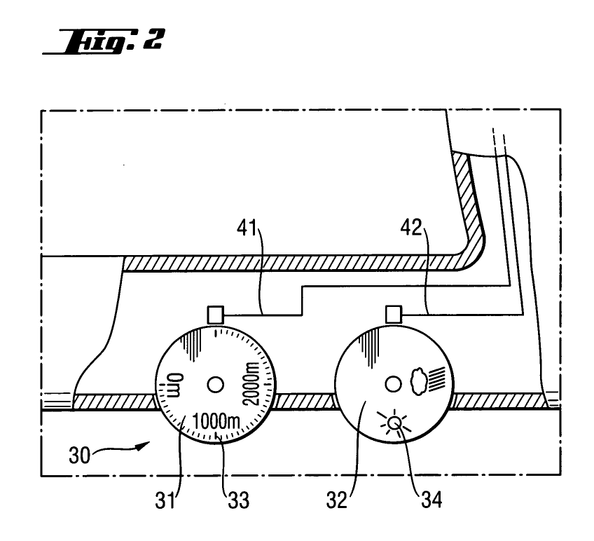

### DETAILED DESCRIPTION OF THE PREFERRED EMBODIMENTS

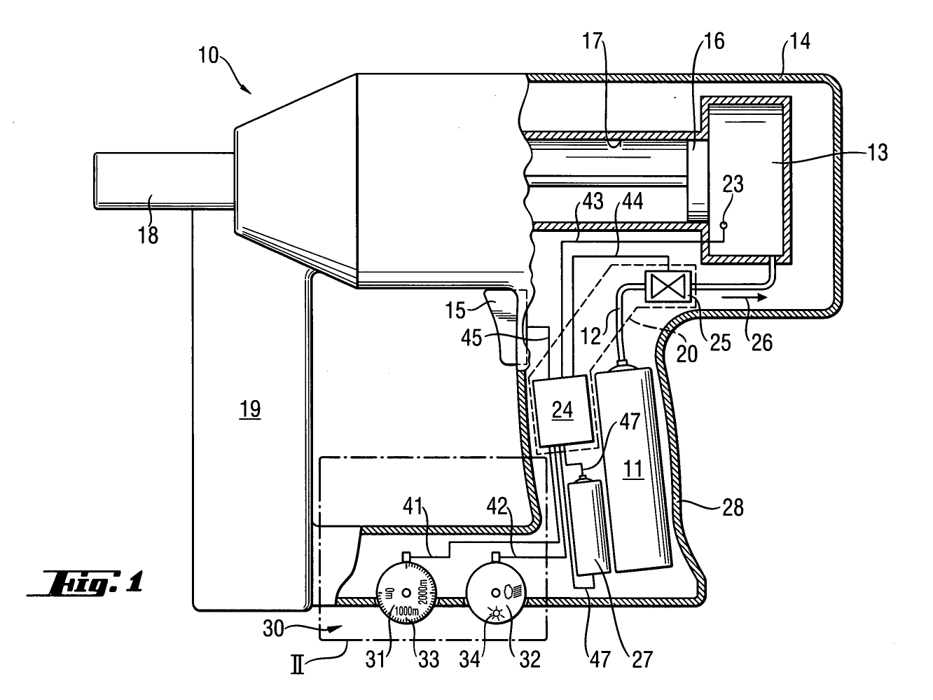

A fuel gas-operated setting tool 10 according to the present invention is shown in FIG. 1 in its initial or idle position. The inventive setting tool 10 has a housing 14 in which there is arranged a setting mechanism with which a fastening element such as a nail, bolt, etc. can be driven in a constructional component or the like (not shown) when the setting tool 10 is pressed against the constructional component and is actuated with an actuation switch 15.

The setting mechanism includes, among others, a combustion chamber 13, a piston guide 17, a drive piston 16 displaceably arranged in the piston guide 17, and a bolt guide 18 into which a fastening element can be fed. The fastening element is displaced and can be driven in the constructional component by a forward displaceable, setting direction end of the drive piston 16. The fastening elements can be stored in a magazine 19 secured on the setting tool 10.

In the combustion chamber 13, there is located an ignition unit 23 such as, e.g., an ignition plug for igniting an air-fuel mixture, which is brought into the combustion chamber 13, for effecting a setting process. Feeding of the fuel (shown with an arrow 26 that indicates the flow direction) into the combustion space or combustion chamber 13 is effected through a fuel conduit 12 from a fuel reservoir 11. The fuel reservoir 11 can be formed as a tank which is fixedly secured on the setting tool 10 or as a pressure capsule.

The setting tool 10 is provided with a metering device, which is generally designated with a reference numeral 20, for adjusting an oxidation medium-fuel ratio of an oxidation medium-fuel mixture. With the metering device 20, a predetermined volume of fuel, necessary for effecting a setting process, is metered-out and fed to the combustion chamber 13. To this metered-out volume of fuel, a predetermined volume of an oxidation medium, e.g., of surrounding air is added.

In the embodiment of the setting tool 10 shown in the drawings, the metering device 20 includes a metering valve 25 and a control unit 24. The metering valve 25, which is arranged in the fuel conduit 12 between the combustion chamber 13 and the fuel reservoir 11, is formed as an electronically controlled valve, e.g., as a piezo valve or as a solenoid valve. The control unit 24 is formed as an electronic control unit and is connected by electrical conductors 47 with a power source 27, e.g., a battery or an accumulator.

The control device 24 can be provided with a data processing unit such as, e.g., a microprocessor with which a control program for one or several tool functions can be executed. The control device 24 controls metering of fuel by controlling functioning of the electronically controlled metering valve 25. To this end, an electrical conductor 44 connects the control unit 24 with the electronically controlled metering valve 25.

An electrical conductor 43 connects the control unit 24 with the ignition unit 23 for transmitting thereto an ignition pulse. An electrical conductor 45 connects the actuation switch 15, which is provided on a handle 28 of the setting tool 10, with the control until 24 for transmitting thereto an actuation pulse.

The setting tool 10 is further provided with an adjusting arrangement 30 with which the tool operator can adjust the setting tool 10 in accordance with site parameters such as, e.g., height over the sea level and meteorological conditions. The site parameters determine the ambient pressure as it is correlated with the site parameters. The height over the sea level and the meteorological conditions can be more easily asserted than the ambient pressure.

The adjustment arrangement 30 includes a selector switch 31 that is provided with a scale 33. The scale 33 is formed as a meter scale, as shown in the drawings. The operator can set on the selector switch 31, the height over the sea level in meters, thereby indirectly adjusting the air or ambient pressure.

The control device 24, which is connected with the selector switch 31 by an electrical conductor 41, associates the height data with an air pressure that corresponds to the determined height over the sea level. With a second selector switch 32, which also forms part of the adjustment arrangement 30, the prevailing meteorological conditions can also be input as site parameters, using the scale 34. The control device 24, which is connected with the selector switch 32 by an electrical conductor 42, correlates the weather-dependent site parameters, indirectly as in the case of the height above the sea level, with the air pressure, dependent on whether low pressure or high pressure prevails. The control device 24 correspondingly controls the metering valve 25 in accordance with data input on the selector switches 31 and 32, so that an optimal fuel volume corresponding to the prevailing air pressure is metered-out. In this way, an air-fuel mixture, which is optimally adapted to the ambient conditions, is fed into the combustion chamber 13.

The metering device can also be formed as a pure mechanically operated device containing, e.g., a mechanical metering valve, a metering pump, or a metering chamber, and, if needed, a regulating device. With so formed metering device, the adjusting arrangement can directly influence the metered-out fuel volume, e.g., the adjusting device or arrangement can cooperate mechanically with an adjusting member for changing the size of the metering chamber. The adjusting arrangement can also be mechanically connected with a displacement member of a metering pump for changing a displacement stroke. It should be understood that instead of the fuel amount, the amount of the oxidation medium can be controlled for adjusting the oxidation medium-fuel ratio.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A combustion-engined setting tool for driving a fastening element in a constructional component, comprising a combustion chamber (13) in which an oxidation medium-fuel mixture is combusted; a device for adjusting an oxidation medium-fuel ratio of the oxidation medium-fuel mixture; and manually-operated adjusting means (30) for inputting site parameters and connected with the adjusting device for setting the oxidation medium-fuel ratio of the oxidation medium-fuel mixture.

2. A setting tool according to claim 1, wherein the adjusting device comprises a device (20) for metering a measured metered-out fuel volume and including a control unit (24), the adjusting means (30) communicating with the control unit (24) which determines the measured metered-out fuel volume based on the site parameters communicated by the adjusting means (30).

3. A setting tool according to claim 1, wherein the adjusting means (30) comprises means for manually inputting a geographical height of a site as a site parameter.

4. A setting tool according to claim 1 wherein the adjusting means (30) comprises means for manually inputting the meteorological conditions as site parameters.

5. A setting tool according to claim 3, wherein the geographical height manually imputing means comprises a scale (33).

6. A setting tool according to claim 4, wherein the meteorological condition manually imputing means comprises a scale (34).

7. A setting tool according to claim 5, wherein the scale (33) is formed as a meter scale indicating heights in meters

8. A setting tool according to claim 6, wherein the scale (34) is formed as a weather conditions-indicating scale.

9. A setting tool according to claim 1, wherein the adjusting means (3) comprises a selector switch (31, 32) for inputting at least one site parameter.
